(19) United States
(12) Patent Application Publication
(10) Pub. No.: US 2003/0232679 A1
(43) Pub. Date: Dec. 18, 2003

(54) Bi-powered clutchless variable speed transmission

(76) Inventor: William R. Cole, Plainfield, IN (US)

Correspondence Address: WILLIAM R. COLE, 8760 S. C.R. 825 E., PLAINFIELD, IN, 46168, US

(21) Appl. No.: 10/461,570

(22) Filed: Jun. 14, 2003

Related U.S. Application Data
(60) Provisional application No. 60/389,390, filed on Jun. 17, 2002.

(51) Int. Cl. F16H 3/72

(52) U.S. Cl. 475/7

(57) ABSTRACT

When motor 1 is powered up and running the primary shaft is connected to the Planetary Gear assembly B, while motor 2 is not running. The output shaft out of Planetary Gear assembly A is zero. As power goes through Planetary Gear assembly B and transfers the power through the bevel gear and then the worm gear on Planetary gear assembly A, which then rotates the ring gear at the appropriate speed to cause the Planetary Gears to remain stationary about the sun gear. Consequently no power is transferred to the output shaft. When motor 2 is powered up, and as its speed increases it starts the rotation of the ring gear on Planetary Gear assembly B and causes the output shaft to reduce its speed and in turn this change in speed is transferred to the ring gear on Planetary Gear assembly A which now starts the rotation of the output shaft of assembly A.

### DESCRIPTION

This present invention relates to a clutchless transmission, and more particularly to a bi-powered clutchless variable speed transmission for use in motor driven assemblies.

### SUMMARY OF THE INVENTION

The first objective of the present invention in the case of an automobile or truck transmission is to reduce gas mileage.

A second objective of the present invention is in the case of electric motors it could possibly eliminate starters.

A third objective of the present invention is that it could expand the use of different types of primary operating power.

### BRIEF DESCRIPTION OF THE DRAWINGS

The invention is described below with reference to the following figures.

FIG. 1 is a schematic plan view of the Bi-Powered Clutches Variable Speed Transmision.

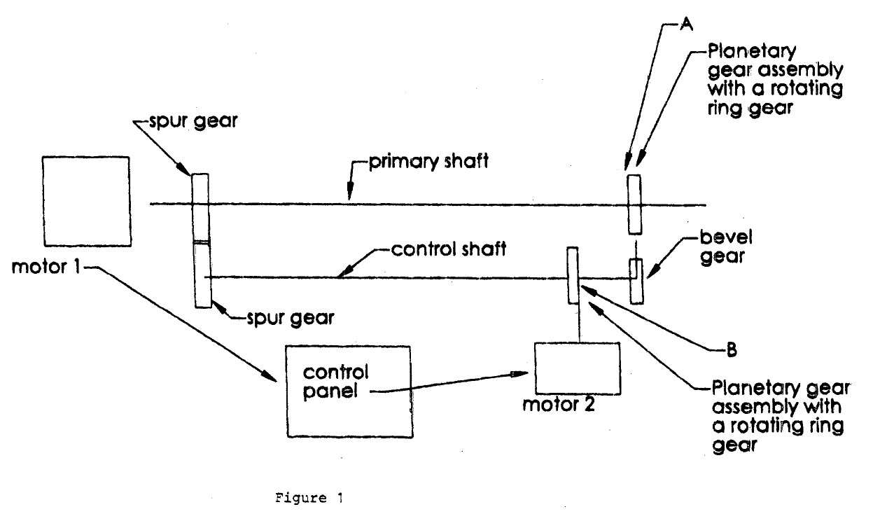

FIG. 2 is a descriptive drawing of the modified planetary system which is shown in FIG. 1, A and B.

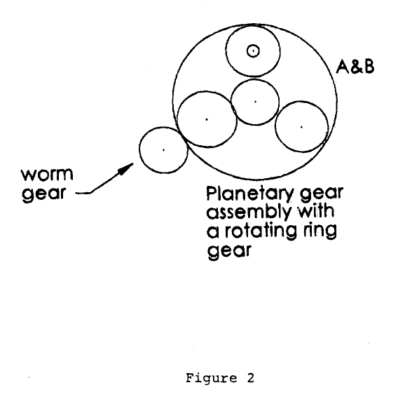

What is claimed is:

1. A bi-powered clutchless variable speed transmission drive assembly:
one of the primary benefits of this bi-powered clutchless variable speed transmission is the ability to control the speed of the output shaft.

2. A bi-powered clutchless variable speed transmission drive assembly:
also has the ability of operating on an infinite variable speed.

3. A bi-powered clutchless variable speed transmission drive assembly:
also has the ability to receive power from motor 1 regardless of its type of power system

4. A bi-powered clutchless variable speed transmission drive assembly:
motor 2 also has the ability to operate under any type of power system

5. A bi-powered clutchless variable speed transmission drive assembly:
operates with two separate planetary gears both with a rotating ring gear A & B as represented on the drawing.
